(19) United States
(12) Patent Application Publication
(10) Pub. No.: US 2025/0090398 A1
(43) Pub. Date: Mar. 20, 2025

(54) Adjustable support apparatus

(71) Applicant: ZHIQI ZHOU, Shenzhen (CN)

(72) Inventor: XIAOPING WU, Shenzhen (CN)

(21) Appl. No.: 18/889,603

(22) Filed: Sep. 19, 2024

(30) Foreign Application Priority Data
Sep. 19, 2023 (CN) 202322556766.5

(51) Int. Cl. A61G 7/053

(52) U.S. Cl. CPC A61G 7/053

(57) ABSTRACT

The present disclosure provides an adjustable support apparatus configured for a bed. The adjustable support apparatus includes at least one handrail attachment, each of the at least one handrail attachment includes a fixing assembly configured for fixing a corresponding handrail attachment of the at least one handrail attachment to the bed and a handrail component telescopically connected to the fixing assembly and located at a side edge of the bed, and configured for providing lateral support to patients; and a pedal element telescopically connected and arranged in sequence with the handrail component, configured to be attached below an approximate center of the bed edge of the bed.

### RELATED APPLICATIONS

This application claims the benefit of priority to Chinese Patent Application Number 202322556766.5 filed on Sep. 19, 2023, in the China National Intellectual Property Administration. The entire contents of the above-identified application are hereby incorporated by reference.

### TECHNICAL FIELD

The disclosure relates generally to devices for assisting and supporting persons, and particularly to an adjustable support apparatus.

### BACKGROUND

To assist weak patients to stand up, a handrail attachment is usually installed on at least one side of the bed to provide support for the patients. Existing handrail attachments often only consider the difficulty of weak patients getting up, but do not take into account the difficulty of weak patients getting in and out of bed, as well as the difficulty of getting in and out of bed when the mattress or the bed itself is high. Therefore, there is a need for handrail attachments that can not only assisting patients to stand up, but also assisting the patient to get in and out of bed.

### BRIEF DESCRIPTION OF DRAWINGS

Embodiments of the present disclosure will now be described, by way of embodiment, with reference to the attached figures.

FIG. 1 is a perspective structural view of an adjustable support apparatus according to a first embodiment of the present disclosure.

FIG. 2 is a perspective view showing a mattress in a state as shown in FIG. 1 with the mattress being removed from a bed.

FIG. 3 is another perspective structural view of the adjustable support apparatus shown in FIG. 1.

FIG. 4 is an exploded view of the adjustable support apparatus shown in FIG. 3.

FIG. 5 is a perspective structural view of an adjustable support apparatus of a second embodiment of the present disclosure in a bed-mounted state.

FIG. 6 is a perspective view showing a mattress in a state as shown in FIG. 5 with the mattress being removed from a bed.

FIG. 7 is another perspective structural view of the adjustable support apparatus shown in FIG. 5.

FIG. 8 is an exploded view of the adjustable support apparatus shown in FIG. 7.

FIG. 9 is a perspective structural view of an adjustable support apparatus of a third embodiment of the disclosure in a bed state.

FIG. 10 is a perspective view showing a mattress in a state shown in FIG. 9 with the mattress being removed from a bed.

FIG. 11 is another perspective structural view of the adjustable support apparatus shown in FIG. 9.

FIG. 12 is a perspective structural drawing of the adjustable support apparatus of a fourth embodiment of the disclosure after the upper mattress being removed from an upper mattress when that the adjustable support apparatus is fixed on a bed with two mattresses.

FIG. 13 is a perspective structural view of the adjustable support apparatus shown in FIG. 12 after the upper mattress and a lower mattress are removed with the adjustable support apparatus fixed to the bed with two mattresses.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

### First Embodiment

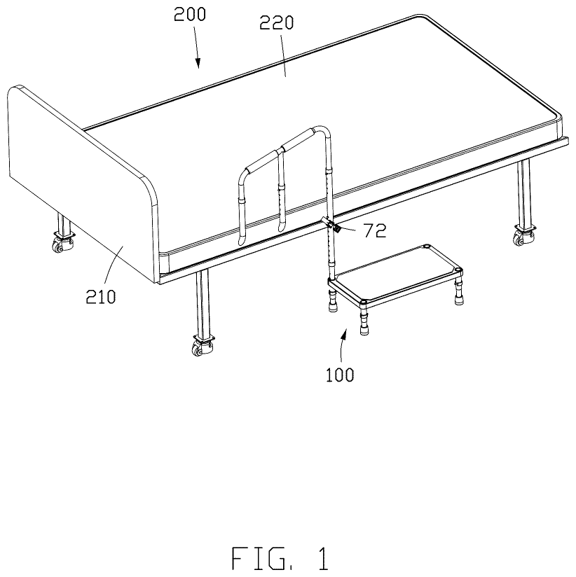

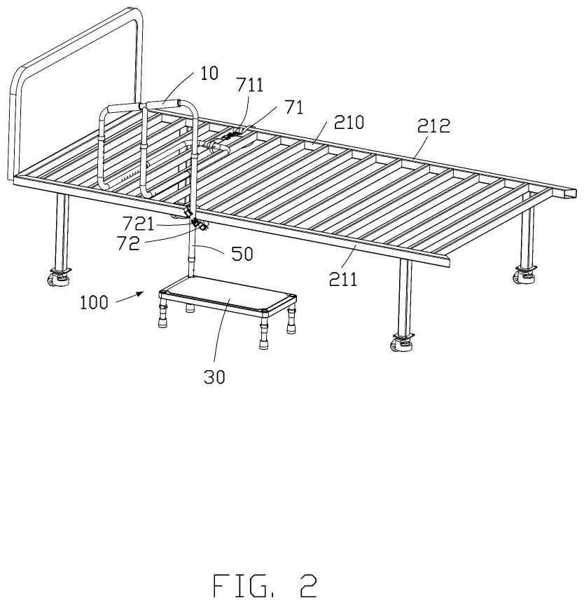

Referring to FIG. 1 to FIG. 4, a first embodiment of the present disclosure provides an adjustable support apparatus 100. The adjustable support apparatus 100 is arranged at one side of a bed 200 and configured for providing lateral support force for patients' body and arm when the patient sitting on the bed 200 wants to lie down or when the patient lying on the bed 200 wants to get up and get out of the bed 200. In addition, the bed 200 further includes a bedstead 210 and a mattress 220, the bedstead 210 is arranged on the mattress 220. The bedstead 210 includes a first bed edge 211 and a second bed edge 212 arranged opposite to the first bed edge 211. In this embodiment, the description is given with the adjustable support apparatus 100 positioned at the first bed edge 211 of the bed 200 as an example. A part of the adjustable support apparatus 100 is adapted to clamp between the bedstead 210 and the mattress 220 of the bed 200, so that the adjustable support apparatus 100 can be firmly arranged on the bed 200.

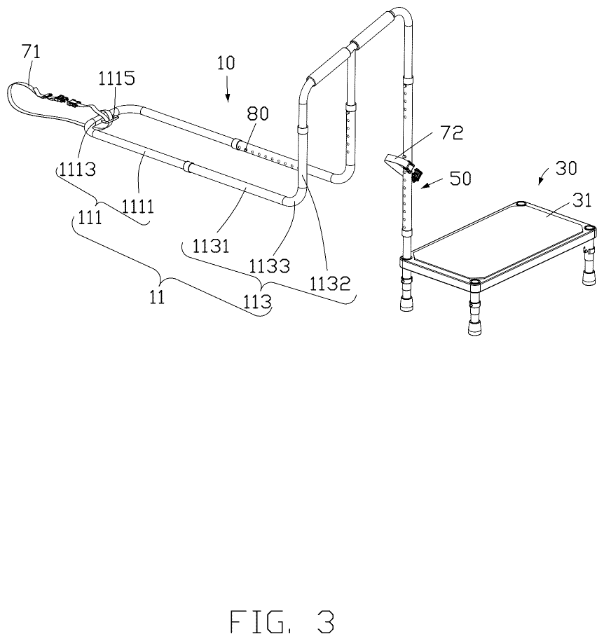

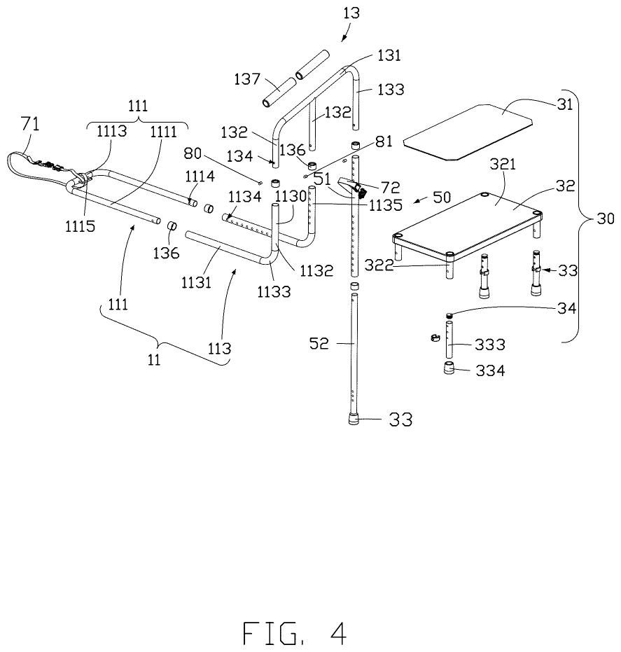

Referring to FIG. 3 and FIG. 4, the adjustable support apparatus 100 of the present embodiment includes a handrail attachment 10, a pedal element 30 (for example, an extending attachment) and a connecting element 50, the handrail attachment 10 and the pedal element 30 are connected via the connecting element 50, so the handrail attachment 10, the connecting element 50, and the pedal element 30 are arranged in a continuous integrated structure.

In the present embodiment, the handrail attachment 10 is arranged on one side of the pedal element 30. The handrail attachment 10 includes a fixing assembly 11 configured for fixing the handrail attachment 10 to the bed, a handrail component 13 telescopically connected to the fixing assembly 11 and configured to be attached at a side edge of the bed 200, and a first strap 71. The fixing assembly 11 is configured for fixing the handrail attachment 10 to the bed 200.

In the present embodiment, the fixing assembly 11 includes a base component 111 and a connecting assembly 113 telescopically connected to the base component 111. The base component 111 is configured to be sandwiched between the bedstead 210 and the mattress 220 of the bed in a used state and includes a pair of spaced first fixing rods 1111 and a second fixing rod 1113 extending between the pair of spaced first fixing rods 1111, the pair of spaced first fixing rods 1111 are disposed in parallel, and ends of the pair of spaced first fixing rods 1111 on the same side are connected to two ends of the second fixing rod 1113, respectively, so that the base component 111 is generally U-shaped in configuration. In the present embodiment, the base component 111 has a hollow tubular structure. Certainly, in other embodiments, the base component 111 may also be in other shapes, for example, in a plate shape, which is not limited herein.

Further, the second fixing rod 1113 is integrated with the pair of spaced first fixing rods 1111. The second fixing rod 1113 includes a protruding portion 1115 disposed on a side, facing the handrail component 13, of the second fixing rod 1113 and an opening defined on the protruding portion 1115. In this embodiment, the opening is configured for the first strap 71 to pass through and tie to the second bed edge 212 of the bed 200, so that the base component 111 is stably arranged on the bed edge of the bed 200, and the first strap 71 can be effectively prevented from sliding on the second fixing rod 1113. In this embodiment, the first strap 71 includes a first snap-fit assembly 711 to make the base component 111 detachable from the second bed edge 212 of the bed 200.

In this embodiment, the fixing assembly 11 is formed by bending a piece of tubing into the generally U-shaped configuration.

The connecting assembly 113 includes a first extending portion 1131 extending horizontally, a second extending portion 1132 extending vertically, and a first transition portion 1133 connected between the first extending portion 1131 and the second extending portion 1132. The first extending portion 1131 is telescopically connected to the base component 111, the second connection section 1132 is telescopically connected to the handrail component 13, and the first extending portion 1131 is arranged substantially perpendicular to the second connection section 1132. That is, in the installation state, the first extending portion 1131 is in a same plane with the base component 111, and the second connection section 1132 is in a same plane with the handrail component 13. In this embodiment, the connecting assembly 113 is formed by bending a piece of tubing into the generally L-shaped configuration.

In this embodiment, the connecting assembly 113 includes a pair of connecting rods 1130 spaced apart from each other, and one end of each of the pair of connecting rods 1130 is telescopically connected to the end of the corresponding one of the spaced first fixing rods 1111.

Further, the connecting rod 1130 is connected to the first fixing rod 1111 through a first retractable fixing structure, so that the relative position between the connecting rod 1130 and the first fixing rod 1111 can be changed according to requirements. In this embodiment, the first retractable fixing structure includes a first fitting hole 1114, a plurality of first through holes 1134, and a first locking member 80. The first fitting hole 1114 is defined in one end, close to the connecting assembly 113, of the first fixing rod 1111. The plurality of first through holes 1134 is defined at intervals at an end thereof close to the first fixing rod 1111. The first locking member 80 is configured for passing through the first fitting hole 1114 and one of the plurality of first through holes 1134, thereby fixing the connecting rod 1130 and the first fixing rod 1111.

In this embodiment, an inner diameter of the connecting rod 1130 is substantially equal to an outer diameter of the first fixing rod 1111, and the two connecting rods 1130 are respectively sleeved at the ends of the two first fixing rods 1111.

In this embodiment, although it is illustrated that the end portion of the first fixing rod 1111 is provided with one first fitting hole 1114, the end of the connecting rod 1130 is provided with a plurality of first through holes 1134, but in other embodiments, the end of the first fixing rod 1111 may be provided with a plurality of first fitting holes 1114 at intervals, the end of the connecting rod 1130 is provided with a plurality of first through holes 1134, or the end of the first fixing rod 1111 is provided with a plurality of first fitting holes 1114 at intervals, the end of the connecting rod 1130 is provided with a first through hole 1134 so long as the first fixing rod 1111 and the connecting rod 1130 can be firmly connected, which is not limited herein.

The handrail component 13 serves to provide lateral support to the patient. The handrail component 13 includes an armrest portion 131, a plurality of first connection portions 132, and a second connection portion 133 (hereinafter the first connection portion 132 and the second connection portion 133 may be simply referred to as a “connection portion”).

In this embodiment, an extending direction of the armrest portion 131 is the same as an extending direction of the first bed edge 211 of the bed 200, and at least a part of the armrest portion 131 is inclined relative to the bed edge of the bed 200. Since at least a part of the armrest portion 131 is obliquely arranged relative to the bed edge of the bed 200, so support for the patient's arms and upper body can be better provided, thereby allowing patients to grip and exert force more easily, aiding them in performing actions such as getting in and out of bed.

In other embodiments, a part of the armrest portion 131 may be obliquely disposed relative to the first bed edge 211, another part of the armrest portion 131 is arranged parallel to the first bed edge 211, or both ends of the armrest portion 131 may be arranged obliquely with respect to the first bed edge 211, furthermore, the two ends incline in different directions, and the middle portion and the bed 200 are arranged in parallel, for example, an inverted U-shaped structure, which is not limited herein.

The plurality of first connecting portions 132 are arranged in parallel at intervals, one end of each of the plurality of first connecting portions 132 is connected to the connecting portion131, and another end of each of the plurality of first connecting portions 132 is telescopically connected to the fixing assembly 11. In the present embodiment, among any two adjacent connection portions 132, a length of the connection portion 132 measured on the side close to the pedal element 30 is greater than a length of the connection portion 132 measured on the side away from the pedal element 30, such that the armrest portion 131 is provided obliquely with respect to the first bed edge 211 of the bed 200. In this embodiment, the plurality of first connecting portions 132 are formed integrally with the armrest portion 131.

In this embodiment, the handrail component 13 includes two first connecting portions 132, and one of the first connecting portions 132 is disposed at an end of the armrest portion 131 away from the pedal element 30, another one of the first connecting portions 132 is provided at a center of the armrest portion 131, and the length of the first connecting portion 132 provided at the end of the armrest portion 131 away from the pedal element 30 is smaller than the length of the first connecting portion 132 provided approximately at the center of the armrest portion 131.

The two first connecting portions 132 are respectively telescopically connected to the corresponding connecting rods 1130 by a second retractable fixing structure. The second retractable fixing structure includes a second fitting hole 134 defined on each of the two first connecting portions 132, a plurality of second through holes 1135 defined at intervals on an end of the second extending portion 1132 of the connecting rod 1130 that is close to the handrail component 13, and a second locking member 81 configured for passing through the second fitting hole 134 and one of the plurality of second through holes 1135, thereby fixing the first connecting portions 132 and the corresponding connecting rod 1130. In this way, users can arbitrarily adjust the height of the handrail component 13 according to requirements, and the structure is simple and convenient to use.

In this embodiment, the end of the second extending portion 1132 of the connecting rod 1130 is sleeved on the first connecting portion 135.

In the assembled state, the two ends of the connecting rod 1130 are further sheathed with a protective member 136, so as to prevent users from being hurt due to the sharp two ends of the connecting rod 1130. The protective member 136 may be made of a silicone material, which is not limited herein.

The second connecting portion 133 and the first connecting portion 132 are spaced apart and parallel to each other and are arranged at the end of the armrest portion 131 close to the pedal element 30. One end of the second connecting portion 133 is arranged to intersect with the armrest portion 131, and another end of the second connecting portion 133 is telescopically connected to the connecting portion 50. In the present embodiment, the second connecting portion 133 is fixedly connected to the connecting element 50 through the third retractable fixing structure. The structure of the third retractable fixing structure is the same as that of the second retractable fixing structure and will not be repeated here.

The pedal element 30 is located below the first bed edge 211 of the bed 200 and has a stepping surface parallel to the floor, the stepping surface is configured for users to step on. The pedal element 30 includes a pedal 31, a support member 32, a plurality of step stools 33, and a sealing member 34. The pedal 31 is configured for users to step on and provided on a surface of the support member 32 away from the floor and has the stepping surface. In this embodiment, the pedal 31 is a substantially rectangular shape. In other embodiments, the pedal 31 can be omitted, that is the feet of the user may rest directly on the support member 32.

Further, the support member 32 includes a base plate 321 which is a plate-like structure and a plurality of mounting portions 322 configured for supporting the base plate 321. In the present embodiment, the base plate 321 has a substantially rectangular shape, and the plurality of mounting portions 322 are arranged on the surface of the base plate 321 facing the floor and configured to attach the corresponding step stool 33. In this embodiment, the mounting portion 322 is a hollow tubular structure and telescopically connected to the step stool 33.

The plurality of step stools 33 is mounted on the corresponding mounting portion 322. In this embodiment, each of the step stool 33 includes a receiving portion 333 and a foot pad portion 334.

In this embodiment, the receiving portion 333 is a hollow tubular structure, one end of the receiving portion 333 is accommodated in the mounting portion 322, and another end of the receiving portion 333 is fixedly connected to the foot pad portion 334. In this embodiment, the receiving portion 333 is telescopically connected to the mounting portion 322 by a fourth retractable fixing structure. The structure of the fourth retractable fixing structure is the same as that of the first retractable fixing structure and will not be repeated here. In this way, users can arbitrarily adjust the height of the base plate 321 according to requirements, and the structure is simple and convenient to use.

Further, the sealing members 34 are respectively provided at ends of the plurality of mounting portions 322 away from the receiving portion 333, so as to prevent dust from entering the mounting portions 322.

While in this embodiment the construction of the pedal element 30 including the pedal 31, the support member 32, the step stools 33, and the sealing 34 is illustrated, in other embodiments, the construction of the pedal element 30 only including the pedal 31 is also possible, in this way, the pedal element 30 as a whole only includes the pedal 31 connected to the handrail attachment 10 via the connecting element 50. In this way, the pedal 31 has a simple structure and is easy to install.

The connecting element 50 is configured for telescopically connecting the pedal element 30 and the handrail attachment 10. Also, the connecting element 50 serves as a support element and configured for supporting the handrail component 10, an end of the support element 50 is configured for contacting a floor. In this embodiment, the connecting element 50 includes a first connecting element 51 and a second connecting element 52 telescopically connected to the first connecting element 51 by using a fifth retractable fixing structure. The inner diameter of the first connecting element 51 is substantially equal to the outer diameter of the second connecting element 52, so that the first connecting element 51 can be sheathed outside the second connecting element 52. The structure of the fifth retractable fixing structure is the same as that of the second retractable fixing structure and will not be repeated here.

In other embodiments, the second connecting element 52 may also only function as a connecting element, which is not limited herein.

Further, the first connecting portion 51 and the second connecting portion 133 also implement a telescopic connection by the five telescopic fixing structure.

Further, in this embodiment, the two ends of the first connecting element 51 are also sheathed with one shielding element 136 to prevent the ends of the first connecting element 51 from scratching the user.

In the present embodiment, the connecting element 50 is configured for connecting the pedal element 30 to the handrail attachment 10. In the present embodiment, the connecting element 50 includes a first connecting element 51 and a second connecting element 52. One end of the first connecting element 51 is telescopically connected to the second connecting portion 133 of the handrail component 13, another end of the second connecting element 52 is telescopically connected to the second connecting element 52, and one end of the second connecting element 52 away from the first connecting element 51 is inserted into the second mounting portions 322. When the adjustable support apparatus 100 of the present embodiment is used, the fixing assembly 11 and the first extending portion 1131 of the connecting assembly 113 are placed on the bedstead 210, and the first strap 71 is wound around the third fixing rod 1113 for at least one turn, and is finally strapped on a the second bed edge 212, the connecting element 50 is bound to the first bed edge 211 by the second strap 72, and then the mattress 220 is placed on the bedstead 210, the handrail attachment 10 can be stably placed on the bed 200. In this embodiment, similarly, the second strap 72 includes a second snap assembly that allows the connector 50 to be removable from the bed 200.

Compared with the prior art, due to the integrated structure of the step stool 30 and handrail attachment 10, it effectively prevents the sliding or displacement that may occur with traditional separate step stools. Moreover, the entire device provides a stepping function without occupying additional space, making it particularly suitable for use in environments with limited space.

### Second Embodiment

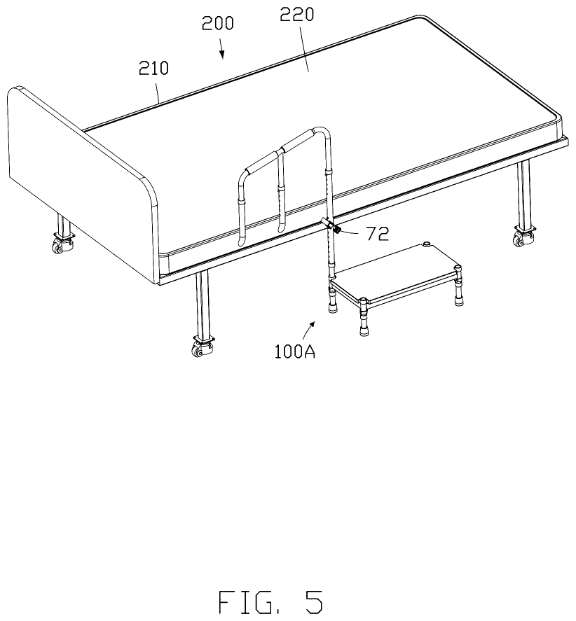

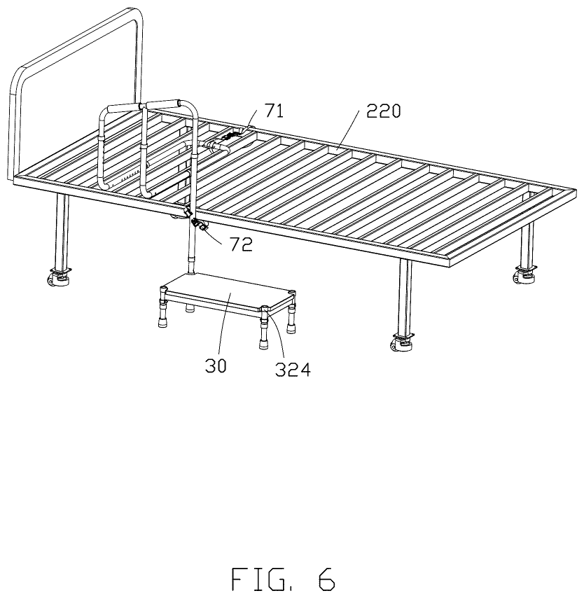

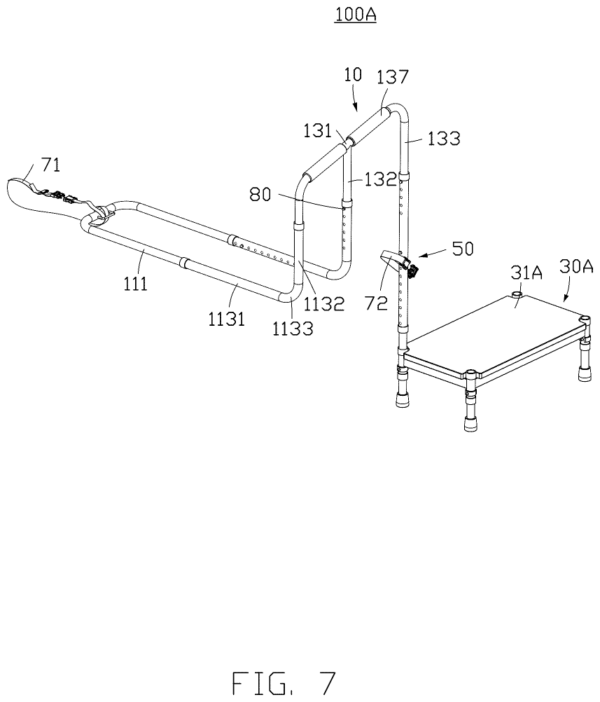

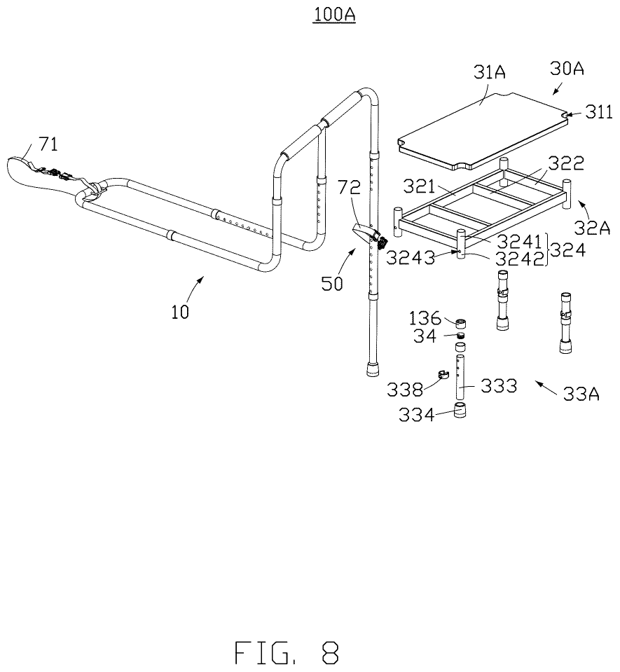

Referring to FIG. 5 to FIG. 8, the adjustable support apparatus 100A of the second embodiment differs from the adjustable support apparatus 100 of the first embodiment in the structure of the pedal element 30A of the present embodiment, and the other structures are the same as those of the first embodiment, and will not be repeated herein.

The pedal element 30A of the adjustable support apparatus 100A of the present embodiment is configured for supporting feet after being taken up by a user. In the present embodiment, the pedal element 30A includes a pedal 31A, a support member 32A, and a plurality of stool feet 33A.

The pedal 31A is disposed on the support member 32A and has a flat plate shape. In this embodiment, the pedal 31A is made of a wood material. However, in other embodiments, the pedal 31A may be made of a ceramic material, a metal material, or the like, which is not limited herein. In the present embodiment, the pedal 31A has a substantially rectangular shape, and four notches 311 are formed in corners of the pedal 31A, respectively.

In this embodiment, the support member 32A includes a support bracket 321 and a plurality of legs 324. In this embodiment, the support bracket 321 is formed by two long-side frames 3211 and four short-side frames 3212, the two long-side frames 3211 are parallel to each other and spaced apart from each other, and the four short-side frames 3212 are parallel to each other and spaced apart from each other between the two long-side frames 3211, two short-side frames 3212 are located at the ends of the long-side frames 3211 so as to form a substantially rectangular frame.

Each corner of the support bracket 321 is provided with a mounting portion 324, and in this embodiment, the number of the mounting portions 324 is four.

Each of the mounting portions 324 includes a first mounting portion 3241 located on the upper side of the support member 32A and a second mounting portion 3242 located on the lower side of the support member 32A. In the present embodiment, the upper side refers to a side of the support member 32A away from the floor, and the lower side refers to a side of the support member 32A facing the floor.

In this embodiment, the first mounting portion 3241 and the second mounting portion 3242 are hollow structures and may or may not be connected, which is not limited herein.

In this embodiment, one end of the connecting element 50 is accommodated in one of the first mounting portions 3241 so as to fixedly connect the handrail attachment 10 to the pedal element 30A. Another end of the first mounting portion 3241 is closed by a seal 34 to prevent dust from entering the first mounting portion 3241.

Further, the step stool 33A of the present embodiment further includes a shielding element 136, that is, the shielding element 136 is sleeved at the end of the receiving portion 333 away from the floor. Certainly, in other embodiments, the shielding element 136 may be omitted, which is not limited herein. Other configurations of the stool support 33A are the same as those of the step stool 33 in the first embodiment and will not be repeated here.

### Third Embodiment

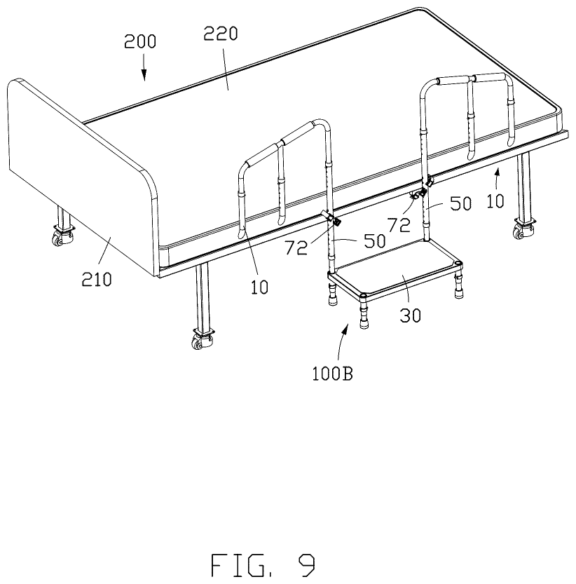

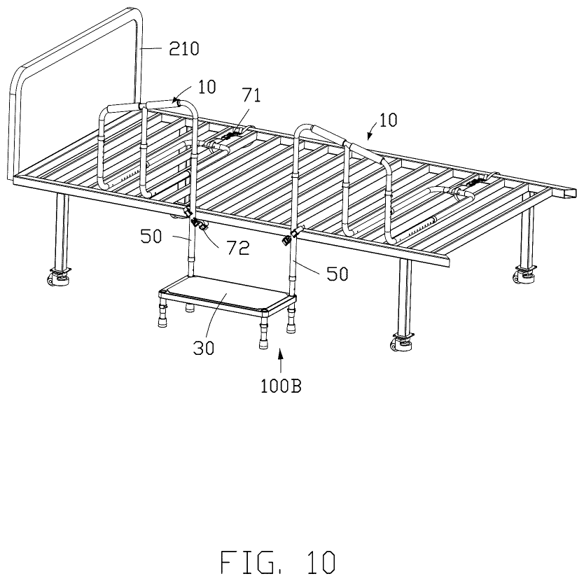

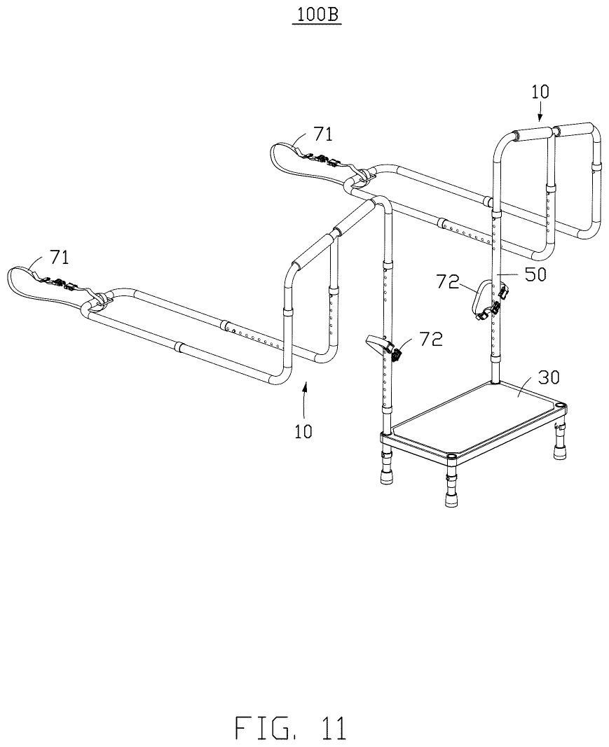

Referring to FIG. 9 to FIG. 11, the adjustable support apparatus 100B of the third embodiment differs from the adjustable support apparatus 100 of the first embodiment in that the adjustable support apparatus 100B in this embodiment includes two handrail attachments 10. The two handrail attachments 10 are respectively arranged at two sides of the pedal element 30, and each of the handrail attachments 10 is connected to the pedal element 30 in the same manner. All of them are connected by a connecting element 50, and other constitutions are the same as those of the first embodiment, and will not be repeated here.

### Fourth Embodiment

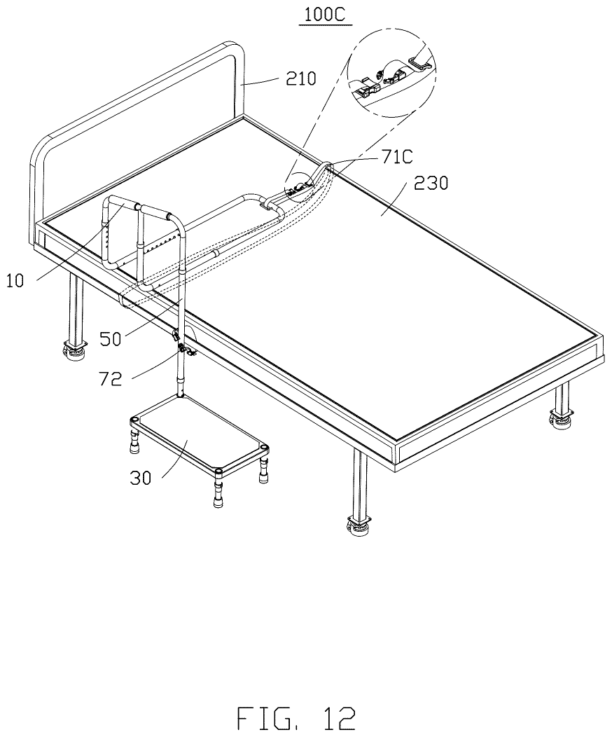

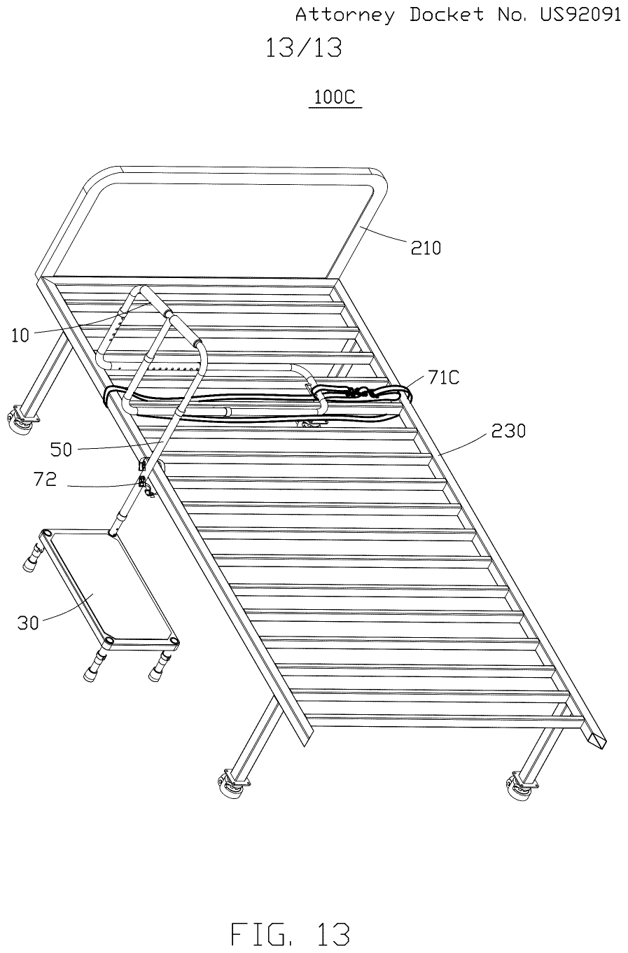

Referring to FIG. 12 to FIG. 13, the adjustable support apparatus 100C of the fourth embodiment differs from the adjustable support apparatus 100 of the first embodiment in that the length of the first strap 71C is different, such that the manner in which the first strap 71C is fixed to the bed 200 is different.

In this embodiment, the adjustable support apparatus 100C applies to a bed 200 having an upper mattress (not shown) and a lower mattress 230 located below the upper mattress. When fixing the handrail attachment 100C to the bed 200, the fixing assembly 11 of the adjustable support apparatus 100C is sandwiched between the upper mattress and the lower mattress 230, one end of the first strap 71C is fixed on the fixing assembly 11, and another end of the first strap 71C is fixed to the first bed edge 211 of the bed 200, so that a part of the lower mattress is sandwiched between the first straps 71C and another part of the lower mattress is sandwiched between the first straps 71C and the fixing assembly 11, thus, the handrail attachment 10 can be firmly arranged on the bed 200.

In other embodiments, the adjustable support apparatus 100C may be fixed on the bed 200 in other manners, which is not limited herein.

The present disclosure is not limited to the respective embodiments described above, and various modifications can be made within the scope of the claims. Embodiments obtained by appropriately combining technical means that are respectively disclosed in different embodiments are also included in the technical scope of the present disclosure. Further, new features can be formed by combining technical means disclosed in each embodiment.

What is claimed is:

1. An adjustable support apparatus configured for a bed, comprising:
at least one handrail attachment, each of the at least one handrail attachment comprising:
a fixing assembly configured for fixing a corresponding handrail attachment of the at least one handrail attachment to the bed; and
a handrail component telescopically connected to the fixing assembly and configured to be attached at a side edge of the bed, the handrail component configured for providing lateral support to users; and
a pedal element telescopically connected and arranged in sequence with the handrail component and configured to be attached below an approximate center of a bed edge of the bed.

2. The adjustable support apparatus according to claim 1, wherein the handrail component comprises an armrest portion extending along an extending direction of the bed edge of the bed, at least a part of the armrest portion is obliquely arranged relative to the bed edge of the bed.

3. The adjustable support apparatus according to claim 2, wherein the handrail component further comprises a plurality of first connecting portions arranged in parallel at intervals, one end of each of the plurality of first connection portions is connected to the armrest portion, and another end of each of the plurality of first connection portions is telescopically connected to the fixing assembly.

4. The adjustable support apparatus according to claim 3, wherein in any two adjacent first connection portions, a length of the first connection portion measured on a side close to the pedal element is greater than a length of the first connection portion measured on a side away from the pedal element.

5. The adjustable support apparatus according to claim 3, wherein each of the at least one handrail attachment comprises a connecting element configured for connecting the handrail attachment and the pedal element.

6. The adjustable support apparatus according to claim 5, wherein the handrail component further comprises a second connecting portion arranged parallel to the plurality of first connecting portions, one end of the second connection portion is connected to the armrest portion, and another end of the second connection portion is telescopically connected to the connecting element.

7. The adjustable support apparatus according to claim 6, wherein a length of the second connecting portion is greater than the length of the first connection portion.

8. The adjustable support apparatus according to claim 1, wherein the fixing assembly comprises:
a base component configured to be sandwiched between a bedstead and a mattress of the bed in a used state; and
a connecting assembly comprising a first extending portion extending horizontally and a second extending portion extending vertically and integrated with the first extending portion, wherein the first extending portion is telescopically connected to the base component, the second connection section is telescopically connected to the handrail component.

9. The adjustable support apparatus according to claim 8, wherein the base component comprises a pair of spaced first fixing rods and a second fixing rod extending between the pair of first fixing rods, the pair of first fixing rods are disposed in parallel, one end of each of the pair of first fixing rods is connected to the corresponding end of the second fixing rod, and another end of each of the pair of first fixing rods is telescopically connected to the corresponding first extending portion.

10. The adjustable support apparatus according to claim 9, wherein the second fixing rod comprises a protrusion portion and an opening defined on the protrusion portion, the opening is configured for a first strap to pass through.

11. The adjustable support apparatus according to claim 1, wherein the pedal element comprises a pedal configured for users to step on.

12. The adjustable support apparatus according to claim 11, wherein the pedal element further comprises:
a support member configured for supporting the pedal; and
a plurality of stool feet respectively arranged at intervals on one side of the support member and telescopically connected to the support member.

13. The adjustable support apparatus of claim 12, wherein each of the at least one handrail attachment comprises a connecting element configured for connecting the corresponding handrail attachment and the pedal element, a portion of the connecting element serves as one stool foot of the pedal element.

14. The adjustable support apparatus of claim 13, wherein the connecting element comprises a first connecting element and a second connecting element telescopically connected to the first connecting element.

15. An adjustable support apparatus configured for a bed comprising a bedstead, comprising:
a fixing assembly configured to be arranged on the bedstead of the bed; and
a handrail component telescopically connected to the fixing assembly and configured to be attached above a side edge of the bed and configured for providing lateral support to users, wherein the handrail component comprises a support element extending vertically and configured for supporting the handrail component, an end of the support element is configured for contacting a floor; and
an extending attachment connected to the end of the support element and extending along a side edge of the bed, and having a stepping surface parallel to the floor.

16. The adjustable support apparatus according to claim 15, wherein the handrail component comprises an armrest portion extending along an extending direction of the bed edge of the bed, at least a part of the armrest portion is obliquely arranged relative to the bed edge of the bed.

17. The adjustable support apparatus according to claim 16, wherein the handrail component further comprises a plurality of first connecting portions arranged in parallel at intervals, one end of each of the plurality of first connection portions is connected to the armrest portion, and another end of each of the plurality of first connection portions is telescopically connected to the fixing assembly.

18. The adjustable support apparatus according to claim 17, wherein in any two adjacent first connection portions, a length of the first connection portion measured on a side close to the pedal element is greater than a length of the first connection portion measured on a side away from the pedal element.

19. The adjustable support apparatus according to claim 17, wherein the handrail component further comprises a second connecting portion arranged parallel to the first connecting portions, one end of the second connection portion is connected to the armrest portion, and another end of the second connection portion is telescopically connected to the support element.

20. The adjustable support apparatus according to claim 19, wherein a length of the second connecting portion is greater than the length of the first connection portion.
